(19) United States
(12) Patent Application Publication
(10) Pub. No.: US 2004/0257811 A1
(43) Pub. Date: Dec. 23, 2004

(54) Illumination enhanced apparatus

(76) Inventor: Shui Chuan Chiang, Hsinfeng (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/464,465

(22) Filed: Jun. 19, 2003

(51) Int. Cl. F21V 33/00

(52) U.S. Cl. 362/253; 362/260

(57) ABSTRACT

An illumination enhanced apparatus of image scanning module includes a transparent sheet for placing the script thereon, at least an illuminant be set under the glass and a reflective device set on the side of the illumination. The reflective device has at least two reflective curved surfaces. These two reflective curved surfaces are set on two sides of the illumination. The reflective curved surfaces are formed according to a portion of elliptic surfaces. Each reflective curved surface has first focus and second focus. The first focuses of reflective curved surfaces are set at the same point and the illuminant is disposed at this point. Therefore, the light irradiated from the illuminant can be focused on the second focuses of reflective curved surfaces reflectively, and then the light focused on the second focuses of reflective curved surfaces can be project to the script. The brightness of the range of scanning area can be improved and became uniform.

### BACKGROUND OF THE INVENTION

1. Field of the Invention

The present invention generally relates to an illumination enhanced apparatus which is adaptable to the application of image scanning module, and in particular to an illumination enhanced apparatus which is provided with the curved reflective surfaces in a portion of elliptic shape.

2. The Related Art

Conventional scanning method of image scanning module, for example, scanner, copy machine, facsimile machine, and so on, is project the light from an illuminant to the scripts which are prepared for scanning and recording. There is a disadvantage about the conventional scanning method. The light irradiated from the illuminant cannot be utilized completely. Accordingly, an illumination enhanced apparatus had been produced. The conventional illumination enhanced apparatus uses a reflector to reflect the light which is not utilized to the script in order to attain the purpose of improving the brightness on the script. In FIG. 5, a scanner optical module 20 has an illuminant 201. The illuminant 201 can be a fluorescent lamp or other lamps. A reflector 202 set on the lateral of the illuminant 201. A reflector 202 is an inclined plane for reflecting the light from the illuminant 201 to the script. The method of utilizing inclined plane for reflecting the light to the script is the most popular way. It can increase the illumination to about 1.7 times.

Another conventional embodiment of a scanner optical module has shown in FIG. 6. The scanner optical module has a reflector 203 made by a circular shape, and a condenser 204 disposed at the outlet of the reflector 203. The condenser 204 congregates the light from the circular reflector 203 and projects to the script. Because of the circular shape of the reflector 203, this embodiment can increase the illumination to 2.0 times. Further referring to FIG. 7, in order to increase the illumination, the reflector 205 is made in elliptic shape. The elliptic-shaped reflector can increase the illumination to about 2.5 times.

Although the aforementioned conventional embodiments can increasing the illumination from 1.7 to 2.5 times, the illuminated range of the script in optical module 20 of general scanner is limited at a point or a line. Actually, the scanning and recording area should be a slight width about 3 millimeters. Notwithstanding the conventional embodiments increase the illumination reflected to the script, they cannot solve the problem of uniformity and sufficiency of the illumination on the script.

### SUMMARY OF THE INVENTION

An object of the present invention is to provide an illumination enhanced apparatus of an image scanning module. The illumination enhanced apparatus comprises at least one illuminant and a reflective device set on the lateral of the illuminant. The reflective device has at least two reflective surfaces with elliptic shape. The reflective surfaces are disposed on the lateral of the illuminant. Each of the reflective surfaces has a first focus and a second focus. The first focuses of the reflective elliptic surfaces are set at the same point and the illuminant is also set on this point of the first focuses of the reflective elliptic surfaces. The light from the illuminant is reflected to the script by the elliptic reflective surfaces, so that the illumination on the script is enhanced.

Another object of the present invention is to provide an illumination enhanced apparatus of an image scanning module, wherein the second focuses of each reflective elliptic surfaces are located below the script respectively. The light reflected by the reflector can be congregated in the second focuses and then projected to the script. Accordingly, there is enhanced and uniform illumination on the scanning and recording area of the script.

The above and other objects, features and advantages in accordance with the present invention will become apparent from the following detailed description of preferred embodiments of the present invention, and taken in conjunction with the accompanying drawings.

### BRIEF DESCRIPTION OF THE DRAWINGS

The present invention will be apparent to those skilled in the art by reading the following description of a preferred embodiments thereof, with reference to the attached drawings, in which:

FIG. 1 depicts the arrangement of the illuminant and the reflector of the illumination enhanced apparatus in accordance with the present invention;

FIG. 2 depicts another embodiment of the illumination enhanced apparatus of the present invention applied in a penetrative platform scanner;

FIG. 3 shows a further embodiment of the illumination enhanced apparatus in accordance with the present invention;

FIG. 4 is a still further embodiment of the illumination enhanced apparatus in accordance with the present invention;

FIG. 5 is a schematic view of the conventional image scanning module which using a planar reflector;

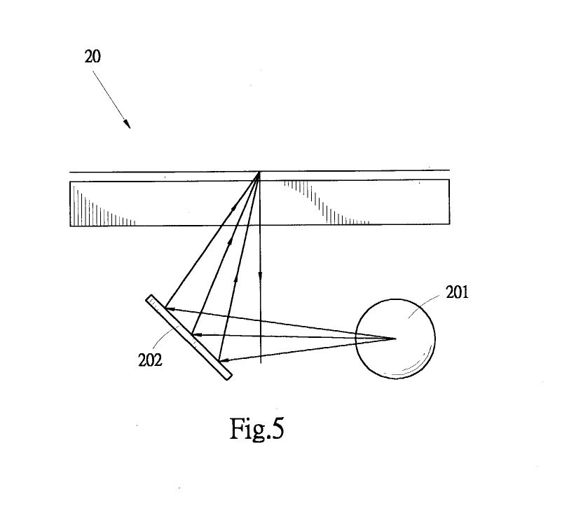

FIG. 6 is a schematic view of the conventional image scanning module which using a circular reflector; and

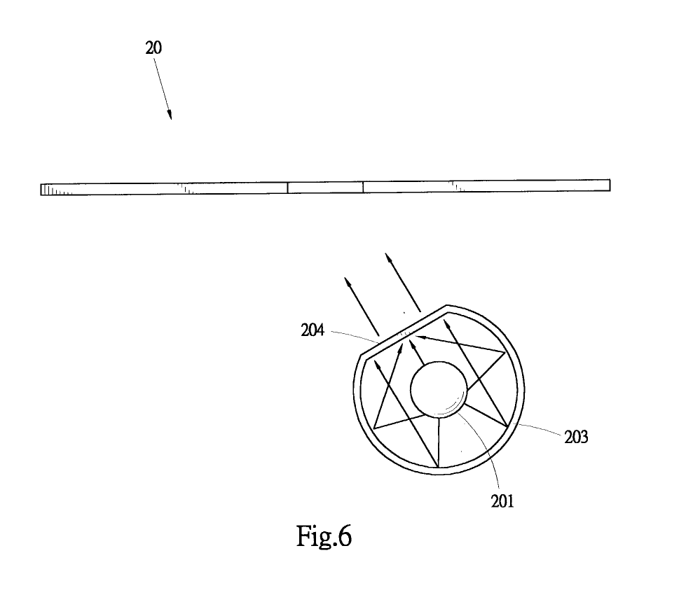

FIG. 7 shows a conventional image scanning module which using an elliptic reflector.

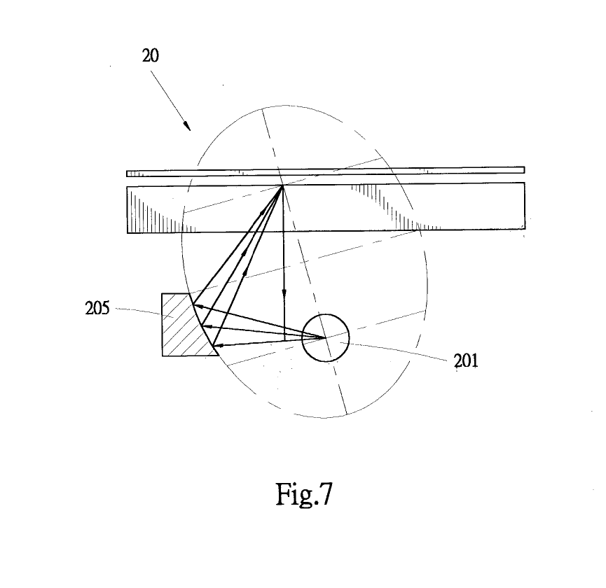

### DETAILED DESCRIPTION OF THE PREFERRED EMBODIMENT

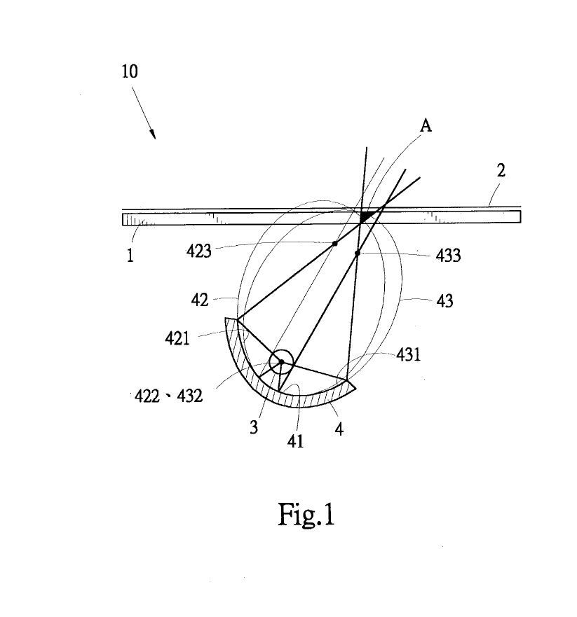

With reference to the drawings and in particular to FIG. 1, an illumination enhanced apparatus 10 can be applied in a scanner, facsimile machine or multi-function office appliance, etc. The illumination enhanced apparatus 10, as shown in FIG. 1, is applied in a reflective platform scanner. The illumination enhanced apparatus 10 is placed under a transparent sheet, such as a glass sheet 1 on which a script 2 is placed for scanning and recording. The illumination enhanced apparatus 10 includes an illuminant 3 which is placed under the glass sheet 1 and a reflector 4 which is set on the side of the illuminant 3. The illuminant 3 can be a fluorescent lamp or other lamps. The light irradiated by the illuminant 3 passes through the glass 1 to the script 2 in order to increase the illumination on the script 2.

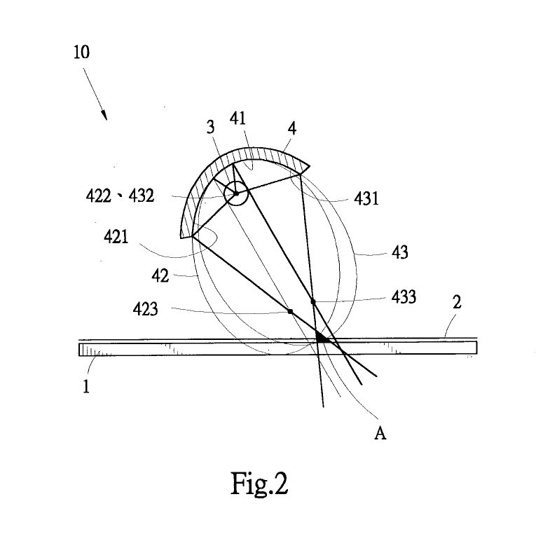

The illumination enhanced apparatus 10 of the present invention can also applied in a penetrative platform scanner. Referring to FIG. 2, the illumination enhanced apparatus 10 is disposed above the glass sheet 1 on which the script 2 is placed for scanning and recording. The illumination enhanced apparatus 10 includes the illuminant 3 which is placed above the glass sheet 1 and a reflector 4 is set on the side of the illuminant 3. The script 2 is made of transparent or semi-transparent material. The illuminant 3 can be a fluorescent lamp or other lamps. The light irradiated by the illuminant 3 and passes through the script 2 and the glass 1 can be congregated by the reflector 4 in order to increase the illumination on the script 2.

The reflector 4 of the present invention has a reflective surface 41 with the specific curved shapes on the inner side of the reflector 4. The reflective surface 41 is composed of a first curved surface 421 and a second curved surface 431 which is connected to the first curved surface 421. The curvature of the curved surfaces 421 and 431 can be identical or different. The curved surfaces 421 and 431 are formed by parts of two virtual ellipsoids 42 and 43 respectively. The first ellipsoid 42 has a first focus 422 and a second focus 423. The second ellipsoid 43 has a first focus 432 and a second focus 433. The first focuses 422 and 432 of the ellipsoids 42 and 43 are set at the same point, and the illuminant 3 is also disposed on this point. The curved surfaces 421 and 431 are placed on the different sides of the illuminant 3. Accordingly, the curved surfaces 421 and 431 reflect and congregate the light irradiated from both sides of the illuminant 3 to the second focuses 423 and 433 of the ellipsoids 42 and 43 respectively.

The second focuses 423 and 433 are different and set apart from the script 2 with a short distance. The light reflected by the reflective surface 41 can pass through the second focuses 423 or 433 then scatter in a short distance before arriving the script 2. Therefore, a scanning area A is formed on the script 2 and receives the light irradiated from the illuminant 3 directly and reflected from the elliptic reflective surfaces 421 and 431. The illumination of the scanning area A can be increased to above 4 times. The most important is that the scanning area A of the script 2 can be provided with a uniform brightness.

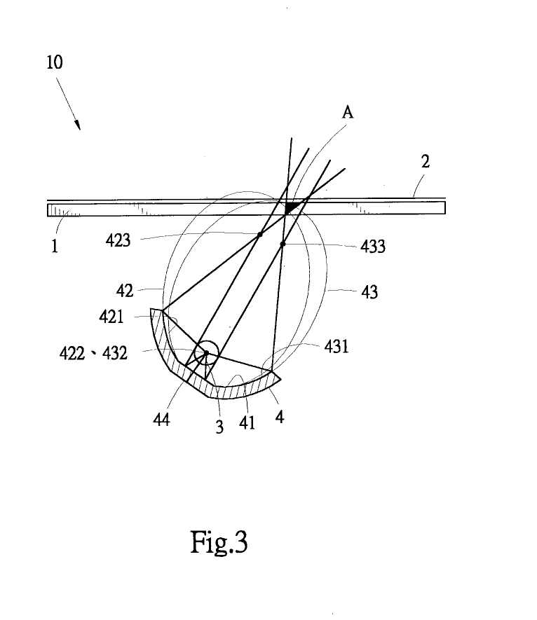

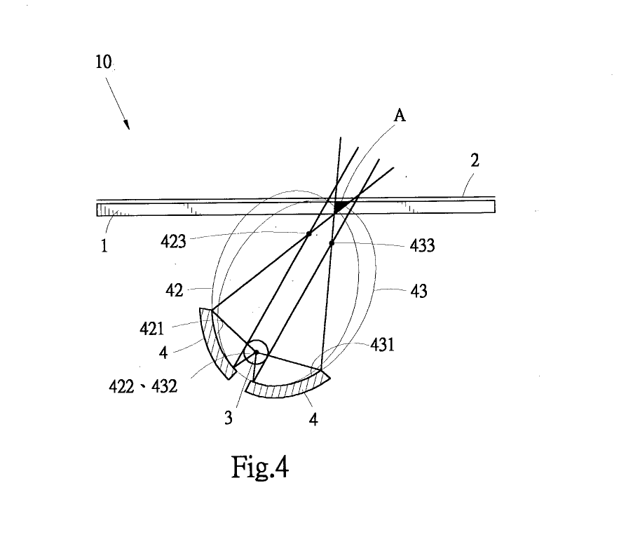

As shown in FIG. 3, the elliptic surfaces 421 and 431 are connected behind the illuminant 3. In practice, a portion of the light reflected by the reflector 4 will be obstructed by the illuminant 3. Thus, a planar connective portion 44 can be formed between the reflective surfaces 421 and 431 in order to reflect the light behind the illuminant 3 to the script 2 directly. Another embodiment shown in FIG. 4, the elliptic reflective surfaces 421 and 431 are separated by a gap behind the illuminant 3 and reflect and congregate the light irradiated from the illuminant 3 to the second focuses 423 and 433 respectively.

As a result of the elliptic reflective surfaces 421 and 431 of the reflector 4, the light projected on the script 2 can be enhanced above four times. Furthermore, the elliptic reflective surfaces 421 and 431 congregate the light from illuminant 3 to the second focuses 423 and 433, and then project on the script 2. The illumination of the scanning area A of the script 2 can be uniformed and enhanced and the quality of scanning by the image scanning module can be improved outstandingly.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. An illumination enhanced apparatus comprising:
at least an illuminant irradiating the light; and
at least a reflector which has a reflective surface, the reflective surface having at least a first curved surface and a second curved surface, the curved surfaces being disposed at different sides of the illuminant, the first curved surface having a first focus and a second focus, the second curved surface having a first focus and a second focus, the first focuses of the curved surfaces being set at the same point which the illuminant is disposed thereon, the light irradiated from the illuminant being reflected and congregated to the second focuses of the first and second curved surfaces respectively before projected to the script.

2. The illumination enhanced apparatus as claimed in claim 1, wherein the illuminant is a fluorescent lamp.

3. The illumination enhanced apparatus as claimed in claim 1, wherein the curved surfaces are parts of elliptic surfaces.

4. The illumination enhanced apparatus as claimed in claim 1, wherein the second focuses of the curved surfaces are set apart from the script with a short distance.

5. The illumination enhanced apparatus as claimed in claim 1, wherein the reflector further comprising a connective portion which connects the first and second curved surfaces and is set behind the illuminant.

6. The illumination enhanced apparatus as claimed in claim 5, wherein the connective portion is in planar shape.

7. The illumination enhanced apparatus as claimed in claim 1, wherein the curved surfaces of the reflector are separated by a gap.

8. The illumination enhanced apparatus as claimed in claim 1, wherein a transparent sheet is disposed above the illuminant and a script is placed on the transparent sheet.

9. The illumination enhanced apparatus as claimed in claim 1, wherein a transparent sheet is disposed under the illuminant and a script is placed on the transparent sheet.
